(19) United States
(12) Patent Application Publication
(10) Pub. No.: US 2004/0261309 A1
(43) Pub. Date: Dec. 30, 2004

(54) Fishing lure

(76) Inventors: Michael T. Shelton, North Charleston, SC (US); Randall R. Hillyer, Summerville, SC (US); Donald W. Rawlins, Brooklet, GA (US)

Correspondence Address: ROBERT H. HAMMER III, P.C., 3121 SPRINGBANK LANE, SUITE I, CHARLOTTE, NC, 28226, US

(21) Appl. No.: 10/460,064

(22) Filed: Jun. 12, 2003

(51) Int. Cl. A01K 85/00

(52) U.S. Cl. 43/42.24

(57) ABSTRACT

A fishing lure or bait is a shaped body of a gelatinous elastomeric composition. The gelatinous elastomeric composition is made from a styrenic block copolymer and an oil mixture of a first oil and a second oil. The first oil has a viscosity and the second oil has a viscosity. The viscosity of the first oil is greater than the viscosity of the second oil. The second oil is in excess of the first oil.

### FIELD OF THE INVENTION

A fishing lure or bait is made of a synthetic rubber composition.

### BACKGROUND OF THE INVENTION

Many commercially available fishing lures and baits are made from plastisol. Plastisol is a dispersion or emulsion of polyvinyl chloride (PVC) resin in a plasticizer. Lures and baits made of various plastisols have been widely accepted. They can be molded into various shapes, are easily colored, and are relatively inexpensive. Additionally, they appear lifelike. The plastisol fishing bait, however, is deficient in that it is not very elastic, it is susceptible to tearing, it is relatively hard (salt water lure—Shore 00 hardness 35-40; fresh water lure—Shore 00 hardness 20+), it is perceived as environmentally unsafe, and while it appears lifelike, it does not feel lifelike.

Recently, it has been proposed that these fishing lures be made of a synthetic rubber as opposed to plastisols. Price, S., “New soft plastic have fishing world excited,” BASSMASTER, July 2002. Stout, L., “Revolutionary Plastics, New technology may radically alter soft plastic lure market,” B.A.S.S. Times, and U.S. Pat. Nos. 5,884,639, 6,117,176, and 6,148,830. Specifically, these synthetic rubbers are thermoplastic elastomers (TPE); and more specifically, they are styrenic block copolymer. These new lures are a significant improvement over the plastisol lures. The new lures can be colored, shaped, are softer, and are elastic. These new lures not only look lifelike, but they also feel lifelike.

The first lures made with these synthetic rubbers, however, were not problem-free. One concern is the surface tackiness of the lure. The synthetic rubber has a high surface tack; therefore, it tends to cling to anything it comes into contact with. One solution to the surface tack concern is set forth in copending U.S. patent application Ser. No. 10/378489 filed Mar. 3, 2003 by M. T. Shelton. Another concern is heat deformation. Heat deformation refers to the body losing its original shape after being exposed to an elevated temperature for a prolonged period of time (e.g. 50° C. for 1 hour). For example, a worm-shaped lure (i.e., generally rod-like) may be bent or folded in storage, and during storage, it may see temperatures greater than 100° F. (38° C.), and after cooling, the bent or folded worm may not return to its original shape. Heat deformation is undesirable from a consumer point-of-view. Still another problem is processibility. Processibility refers to the flowability of the extrudate into the cavities of the mold while retaining reasonable cycle times. The extrudate must have the proper flow characteristics to completely fill all cavities of the mold; such molds may have from 12 to 150 cavities per mold. Still other considerations include maintaining elasticity and tear resistance. Each of these properties must be balanced to achieve a good quality lure. These properties, it is believed, are dependent, in part, on the choice of the components of the synthetic rubber composition and their relative quantities in the mixture.

One prior art composition of blended styrenic block copolymers (SEEPS (styrene ethylene/ethylene-propylene-styrene), SEBS (styrene ethylene/butylene styrene), and SEPS (styrene ethylene/propylene styrene)) and a single oil (SEMTOL) produced lures with unacceptable heat deformation. Another prior art composition of blended styrenic block copolymers (SEEPS, SEBS, SEPS) and equal amounts of two oils (BLANDOL and SEMTOL) had unacceptable processibility. The addition of known heat distortion additives (ENDEX and GE PPO BLENDEX) yielded no improvement to the heat deformation concern. See generally, U.S. patent application Publication No. 2002/01888057A1, Example XXVI.

Accordingly, there is a need for a new fishing lure made of a synthetic rubber composition that has, among other things, low heat deformation and good processibility.

### SUMMARY OF THE INVENTION

A fishing lure or bait is a shaped body of a gelatinous elastomeric composition. The gelatinous elastomeric composition is made from a styrenic block copolymer and an oil mixture of a first oil and a second oil. The first oil has a viscosity and the second oil has a viscosity. The viscosity of the first oil is greater than the viscosity of the second oil. The second oil is in excess of the first oil.

### DESCRIPTION OF THE INVENTION

Lures and baits may come in many various shapes. Lure and bait are used interchangeably herein. For example, the shape may be that of a lizard or a worm. Other shapes include: salamanders, fan tails, curly tail jigs, quad tail jigs, curly tail worms, split-tails, worm-crawfish, minnows, double tails, ripple tail worms, and the like. Further, the shape may also include a ‘rattle pocket’ for a rattle. For example, see U.S. Pat. No. 4,993,183 and U.S. patent application Publication No. 2002/0188057A1, both incorporated herein by reference.

The gelatinous elastomeric composition is a mixture of a thermoplastic elastomer (TPE) and an oil (or plasticizer). Preferably, this composition is a mixture of a styrenic block copolymer and an oil, where the oil is in excess, by weight, of the copolymer. Most preferably, the composition is a mixture of one or more styrenic block copolymers and at least two oils, where the oil is in excess, by weight, of the copolymer and one oil is in excess, by weight, of the other oil.

These gelatinous elastomeric compositions are elastic, tear resistant, and soft. They are elastic and can be stretched several times their original length. They are tear resistant and can withstand tearing. They are soft and have a Shore 00 hardness less than 10, preferably 4-6.

The styrenic block copolymers are thermoplastic elastomers. Their structure normally consists of a block of a rigid styrene on each end with a rubbery phase in the center. Styrenic block copolymers include, but are not limited to, SBS (styrene butadiene styrene), SIS (styrene-isoprene-styrene), SEPS (styrene ethylene/propylene styrene), SEBS (styrene ethylene/butylene styrene), and SEEPS (styrene ethylene/ethylene-propylene-styrene). These materials are commercially available from, for example, SEPTON Company of America, Pasadena, Tex. and Kraton Polymers, Houston, Tex. Exemplary SEPTON (US) products include SEPTON 4055 (SEEPS); SEPTON 8006 (SEBS); and SEPTON 2006 (SEPS). Exemplary Kraton (US) products include KRATON 1651 (SEBS).

The oil or plasticizer generally refers to mineral oils or silicone (dimethyl silaxone) oil. The oil is mixed with the styrenic block copolymer. It was learned during experimental work leading to this invention that increasing the amount of the heavier oils (i.e., greater molecular weights or greater viscosity) decreased heat deformation and processibility, and increased surface tack. Such oils are commercially available from, for example, Crompton Corporation (Witco Refined Products), Greenwich, Connecticut. Exemplary oils include: BLANDOL white mineral oil, specific gravity @ 25° C./25° C. (ASTM D4052)—0.839/0.855; Kinematic viscosity @ 40° C., CST (ASTM D445)—14.2/17.0 (heavy oil), and SEMTOL white mineral oil, specific gravity @ 25° C./25° C. (ASTM D4052)—0.804/0.827, Kinematic viscosity @ 40° C., CST (ASTM D445)—3.9/5.5 (light oil).

Other conventional additives may also be added. Such additives include: UV-stabilizer, heat-stabilizer, pigments, dyes, flavorant, attractants, and the like.

In the gelatinous elastomeric composition, the oil is in excess, by weight, of the styrenic block copolymer. The copolymer may comprise 5-20% by weight of the composition, while the oil may comprise 80-95% by weight of the composition. Preferably, the copolymer comprises about 12-13% of the composition, while the oil comprises about 87-88% of the composition.

The copolymer component of the composition may comprise a single copolymer or a mixture of copolymers. If a single copolymer is used, SEBS is preferred. If a mixture of copolymers is used, SEEPS and SEBS or SEPS/SEBS combinations are preferred. Lures made with SEBS alone are adequate from a elastic and tear resistance perspective, but mixtures can provide superior elastic and tear resistant properties. In the mixtures, it is preferred that the SEEPS component be the major component. Exemplary copolymer component formulations include 4-13% SEEPS, 1-5% SEBS, 0-2% SEPS. Most preferred is 9% SEEPS, 3% SEBS, and 1% SEPS.

The oil component of the composition comprises a mixture of oils. The first oil is a heavier oil than the second oil. Heavier refers to molecular weight and/or viscosity. The first oil and second oil may be equal, by weight, components of the mixture. Preferably, though, the second oil is in excess over the first oil. Most preferably, the second oil comprises at least 55% by weight of the mixture.

### EXAMPLE

The foregoing discussion is further illustrated with reference to the following example. All percentages are weight percentages of the composition. A mixture of: 8.96% SEPTON 4055 (SEEPS), 2.99% SEPTON 8006 (SEBS), 1.04% SEPTON 2006 (SEPS), 34.70% BLANDOL (mineral oil), 52.05% SEMTOL (mineral oil), 0.13% UV-stabilizer (TIN P), and 0.13% heat stabilizer or antioxidant (IRGANOX 1010) are preprocessed. This composition is charged into an extruder with a heated barrel (200-400° F. or 93-205° C.). The composition is shot into the mold and cooled (mold temperature 80-120° F. or 26-49° C). These lures had excellent elasticity and tear resistance, good heat deformation properties, good processibility, and a Shore 00 hardness of 4-6.

The present invention may be embodied in other forms without departing from the spirit and the essential attributes thereof, and, accordingly, reference should be made to the appended claims, rather than to the foregoing specification, as indicated the scope of the invention.

1. A fishing lure or bait comprising a shaped body of a gelatinous elastomeric composition comprising a styrenic block copolymer and an oil mixture of a first oil and a second oil, where said first oil and said second oil are selected from the group consisting of: mineral oils, silicone oils or mixtures thereof;
the first oil having a viscosity and the second oil having a viscosity, the first oil viscosity being greater than the second oil viscosity, the second oil being in excess of the first oil.

2. A fishing lure or bait comprising a shaped body of a gelatinous elastomeric composition comprising a blend of styrenic block copolymers, one styrenic block copolymer being a SEEPS and said SEEPS being a major component of said blend, and an oil mixture of a first oil having a viscosity and a second oil having a viscosity, where said first oil and said second oil are selected from the group consisting of: mineral oils, silicone oils or mixtures thereof;
the first oil viscosity being greater than the second oil viscosity and the second oil being in excess of the first oil.

3. A fishing lure or bait comprising a shaped body of a gelatinous elastomeric composition consisting essentially of 4-13% by weight of the composition of SEEPS, 1-5% by weight of the composition of SEBS, 0-2% by weight of the composition of SEPS, and an oil mixture of a first oil having a viscosity from 13-20 cPs at 40° C. and a second oil having a viscosity from 3-6 cPs at 40° C., and the second oil being in excess of the first oil.

4. A fishing lure or bait comprising a shaped body of a gelatinous elastomeric composition consisting essentially of 4-13% by weight of the composition of SEEPS, 1-5% by weight of the composition of SEBS, 0-2% by weight of the composition of SEPS, 32-38% by weight of the composition of oil with a viscosity from 13-20 cPs at 40° C., and 48-57% by weight of the composition of an oil with a viscosity from 3.5-6 cPs at 40° C.
